(19) United States
(12) Patent Application Publication
(10) Pub. No.: US 2009/0146508 A1
(43) Pub. Date: Jun. 11, 2009

(54) RECIPROCATING POWER GENERATING MODULE

(75) Inventors: WEN-YANG PENG, Hsinchu County (TW); CHUNG-PING CHIANG, Taipei County (TW); CHAN-HSING LO, Hsinchu County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, HSIN-CHU (TW)

(21) Appl. No.: 12/055,218

(22) Filed: Mar. 25, 2008

(30) Foreign Application Priority Data
Dec. 11, 2007 (TW) 096147149

(51) Int. Cl. H02K 35/00

(52) U.S. Cl. 310/15

(57) ABSTRACT

A reciprocating power generating module is disclosed, which comprises: a guide; a magnet, being an integrated unit composed of at least two magnetic elements connected with each other in a manner that poles of any one of the plural magnetic elements are orientated to repel poles of its neighboring magnetic elements; and a coil, being wound around the guide; wherein the magnet is capable of being driven to move linearly by the defining of the guide. The full sine-wave AC voltage output is obtained when the relative linear motion equals double of the length of the magnetic element.

### FIELD OF THE INVENTION

The present invention relates to a reciprocating power generation module, and more particularly, to a reciprocating power generation module, being an integrated unit composed of a plurality of magnets and a multi-cell coil in a manner that the plural magnets are connected with each other for orientating poles of any one of the plural magnets to repel poles of its neighboring magnets.

### BACKGROUND OF THE INVENTION

Electrical generators will find a wide application in all fields of technology. Following the call for less use of batteries, the development for having a compact and highly efficient electrical generator is in high demand. Generally, the compact-sized electrical generator is used as the power supply for portable electronic devices. However, for the proliferation of compact portable electrical generators, it is crucial that those compact portable electrical generators should be able to generate electricity with sufficient capacity in a limited space and can be manufactured with a reasonable cost. Such miniature power generator can be manufactured small enough to be received inside wearable objects at the positions such as inside a bag of clothing, being embedded in the shoe sole of a shoe, being mounted on eyeglasses or received inside a watch, etc., so that it can be used as an emergency power source for devices such as a flash light, a radio, communications devices, and so on.

Reciprocating dynamo flashlights have been available on the market for a conceivable period of time, but for its lack of adequate power generating efficiency, it had been determined to be impractical in usage. In terms of the movement of movers that is performed in an electromagnetic power generator, the driving mode of the electromagnetic power generator can be categorized into three different types which are continuous rotary, swing, and the reciprocating types. Among which, the reciprocating type is the least used even when the linear reciprocating motion is the most direct form of power transmission in many applications since it usually requires to be converted into a rotation motion through a certain mechanism and thus causes the whole system to have poor performance. For those currently available compact-sized reciprocating power generators using magnets as movers, each of which will require to have a stroke that is more than twice the length of its solenoid so as to affecting the same with various magnetic flux. In addition, the power generating efficiency of those conventional compact-sized reciprocating power generators is poor since the design adopted thereby with respect to the arrangement of the magnetic field lines and the way that the coil is being wound enables the polarity direction of the magnet to be parallel to the axis of its solenoid.

Please refer to FIG. 1, which shows a conventional reciprocating dynamo flashlight. As shown in FIG. 1, the conventional reciprocating dynamo flashlight only can achieve its maximum power generation when the magnets 10 are moved to the positions corresponding to the two ends of the coils 12. It is known that the flux density at the two ends of a magnet is not going to increase drastically when it achieves a certain thickness. Therefore, even by serially connecting a plurality of such power generating modules together, it will only cause the volume to increase but not the energy density, so that the sensitivity of the whole power generating device with respect to the external kinetic energy will not be increased.

Thus, it is required to have an improved reciprocating power generating module that is able to design an innovated magnet arrangement for shorting the moving path of magnets inside its coil and thus achieving higher magnetic flux density utilization. Because of the voltage output of a reciprocating power generator is in direct proportion to the product of the moving speed of magnet and the change rate of magnet flux with respect to position variation, the reciprocating power generating module will be able to achieve a high density multi-pole flux path by orientating poles of any one of its magnets to repel poles of its neighboring magnets, and be able to increase its induced electromotive force by increase the change rate of magnet flux with respect to position variation of its coil.

### SUMMARY OF THE INVENTION

The object of the present invention is to provide a reciprocating power generating module, capable of achieving high magnetic flux density utilization and high coil density by cooperation between the magnetic arrangement of the magnets used thereby and the way that the coil is being wound.

To achieve the above object, the present invention provide a reciprocating power generating module, comprising: a guide; a magnet, being an integrated unit composed of a plurality of magnetic elements aligned one next to another in a manner that poles of any one of the plural magnetic elements are orientated to repel poles of its neighboring magnetic elements; and a coil, being wound around the guide; wherein the magnet is capable of being driven to move linearly by the defining of the guide.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a conventional reciprocating dynamo flashlight FIG. 2 is a schematic diagram illustrating the power generating principle of a reciprocating power generating module of the invention.

FIG. 3 is a schematic diagram showing a reciprocating power generating module according to an exemplary embodiment of the invention.

FIG. 4 is a schematic diagram showing two reciprocating power generating modules of the invention used in an energy recovery device.

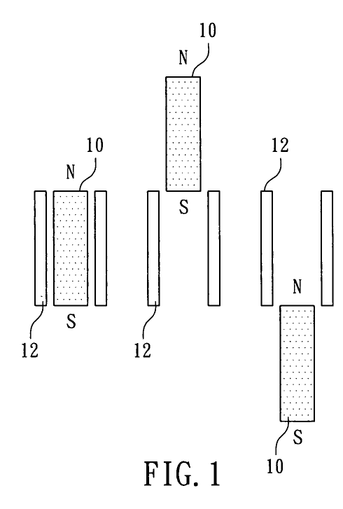

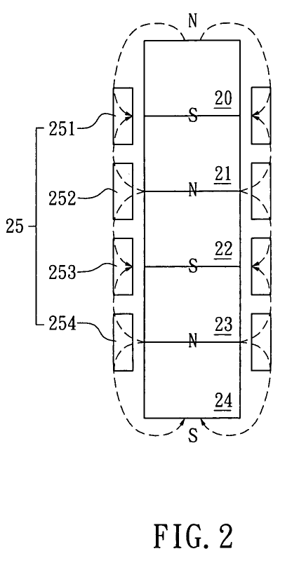

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

Please refer to FIG. 2, which is a schematic diagram illustrating the power generating principle of a reciprocating power generating module of the invention. In the reciprocating power generating module of FIG. 2, there are five anisotropic magnets 20, 21, 22, 23, 24 being connected with each other in a manner that poles of any one of the five magnets are orientated to repel poles of its neighboring magnets, i.e. the North pole of a magnet is disposed facing to the North pole of its neighboring magnet while enabling the South pole of its another neighboring magnet to be orientated to the South pole thereof. Moreover, a coil 25 is wound around the exterior of the concatenating magnets 20, 21, 22, 23, 24 in a series of alternating clockwise and counterclockwise loops, i.e. the winding direction of the sub-coil 251 is opposite to that of its neighboring sub-coil 252, and the winding direction of the sub-coil 252 is further opposite to that of its neighboring sub-coil 253, and furthermore the winding direction of the sub-coil 253 is opposite to that of its neighboring sub-coil 254.

By the aforesaid arrangement, the total length of magnet can be shortened comparing with that used in conventional reciprocating power generators and at the same time that the overall pole number can be increased. In addition, by stacking the magnets in the aforesaid repelling manner, the magnetic field lines are orientated in a direction perpendicular to the coil. Moreover, as the coil is winding in a multi-pole winding manner, the density of the coil is increased so that any minute relative movement between the magnets and the coil can be harvested and thus converted the relating magnetic field variation into electric power for outputting.

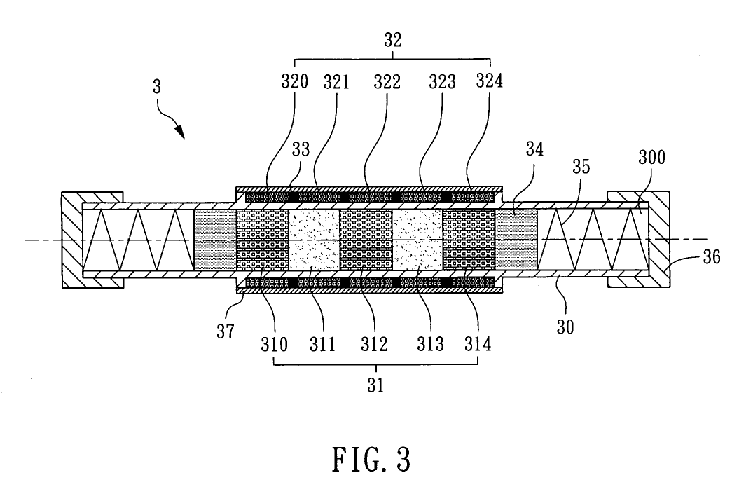

Please refer to FIG. 3, which is a schematic diagram showing a reciprocating power generating module according to an exemplary embodiment of the invention. The reciprocating power generating module 3 is comprised of: an outer tube 30, a magnetic column 31, a coil 32, a yoke ring 33, a weight 34, a spring 35, an end cap 36, and a back iron 37.

The outer tube 30 is a hollow tube having an accommodation space 300 formed therein. The magnetic column 31 is composed of a plurality of anisotropic magnets 310, 311, 312, 313, 314 being connected with each other in a mutually repelling manner. The coil 32 is wound around the exterior of the outer tube 30 in a series of alternating clockwise and counterclockwise loops, i.e. the winding direction of the sub-coil 320 is opposite to that of its neighboring sub-coil 321, and the winding direction of the sub-coil 321 is further opposite to that of its neighboring sub-coil 322, and furthermore the winding direction of the sub-coil 322 is opposite to that of its neighboring sub-coil 323, and the winding direction of the sub-coil 323 is further opposite to that of its neighboring sub-coil 324, in which the sub-coils 320, 321, 322, 323, 324 are separated from each other by the use of the yoke rings 33 as each yoke ring 33 is disposed surrounding the outer tube 30. For enabling the magnetic column 32 of the reciprocating power generating module 3 to performing a linear movement by the defining of the outer tube 30, the magnetic column 32 are attached by weights 34 at the two ends thereof. In addition, there are springs 35 being sandwiched between the weights 34 and their corresponding end caps 35 for exerting a resilience force upon the magnetic column 31 as it is performing the linear movement. In the exemplary embodiment shown in FIG. 3, for enhancing permeability, there is a back iron 37 being arranged outside the coil 32 while surrounding the same.

Under the aforesaid arrangement, a voltage peak can be generated as soon as the relative displacement between the magnetic column 31 and the coil 32 reaches and equal to the length of a single anisotropic magnet, by that, the path traveling by the mover, i.e. the magnetic column 31, can be shortened to one third or one fifth of those required in prior art for achieving instant maximum voltage output.

In another exemplary embodiments of the invention, the plural anisotropic magnets can be glued together or can be connected by screw riveting. Moreover, except for arranging springs 35 between the magnet column 31 and the end caps 36 for obtaining the resilience force, it is possible replace the springs 35 by anisotropic magnets that are repelling to the magnetic column 31 for achieving the same elastic effect as the springs 35 can.

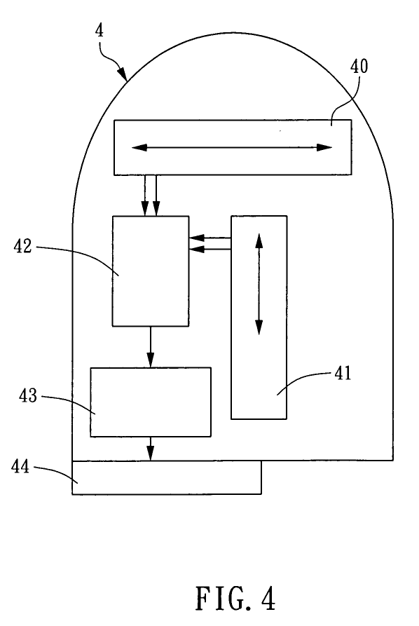

Accordingly, the aforesaid reciprocating power generating module can be adapted as an energy recovery device for recycling energy of a one-dimensional, a two-dimensional, or a three-dimensional movements. As the two-dimensional movement energy recovery device 4 shown in FIG. 4, it is configured with two aforesaid reciprocating power generating modules 40, 41 that are arranged perpendicular to each other and connected respectively to a rectification regulator 42. As the rectification regulator 42 is further connected to a battery 43 which can be a charging capacitor or a secondary battery, the power generated by the two reciprocating power generating modules 40, 41 is stored in the battery 43. In FIG. 4, the battery 43 is further electrically connected to a load 44 or a socket.

Comparing with those conventional reciprocating power generating modules, the advantages of the present invention is listed as following:
(1) As the magnets used in the reciprocating power generating module of the invention is arranged in the aforesaid repelling manner and the coil is wound in a series of alternating clockwise and counterclockwise loops, it is able to generate several voltage during the magnet is performing a reciprocating movement about the coil so that it can generate power with comparatively smaller relative displacement; moreover, by the stacking of more than two magnets or have more than three odd numbered magnets, the flux path is shortened for reducing distance between poles and enhancing surface magnet flux density so that the output energy density is increased.
(2) Generally, as the coil in most common motors adopts multi-pole winding that there are gaps between any two neighboring sub-coils and will result lower coil density, such multi-pole winding is not suitable for mini-sized reciprocating power generators. Nevertheless, the coil in the present invention is wound in a series of alternating clockwise and counterclockwise loops, not only it can achieve a higher coil density, but also the induced electromotive force of each sub-coil is in phase synchronization that can be serially connected in a simple and reliable manner.
(3) As the magnetic intensity of the isotropic magnets is weak that when it is adopted as the magnet of the invention for forming the aforesaid flux path, apparently, the energy density can not be satisfactorily increased. Thus, by adopting anisotropic magnets while stacking the same in the aforesaid repelling manner, the surface magnetic field distribution can be optimized for enabling the coil to have the best cutting effect as the magnet is moving relative to the coil.

It is noted that the coil used in the invention can be formed by injection molding so that it can do without an independent guide tube as the coil is integrally formed therewith. Thereby, the magnet can be guided to move by the defining of the inner surface or the outer surface of the integral-formed outer tube. Moreover, the cross section of the outer tube can be shaped like a circle, a square, or other polygons that is selected as required by users only if it is able to guide the magnet to move smoothly relative to the coil. In addition, for reducing the friction and the noise caused by the contact between the magnet and the outer tube as the magnet is moving relative to the coil, the contact surface between the magnet and the outer tube is surface processed or is configured with a micro-groove structure. In an exemplary embodiment of the invention, the width of each cell provided for sub-coil to wind upon can be equal or not equal to any single magnetic element used in the invention. In addition, there can be magnetic materials to be disposed at positions between any two neighboring magnetic elements to be used for altering the type of flux path; and there also can be magnetic materials to be disposed at positions between any two neighboring sub-coils for enhancing the affection of magnetic flux variation upon the coil.

In another exemplary embodiment of the invention, the springs arranged at the two ends of the outer tube can be replaced by buffering members, such as rubber, soft plastic, or other elastic polymers with buffering ability. It is noted that it is possible to place a spring at one end of the outer tube while placing a buffering member at the other end.

When there are more than two reciprocating power generating modules of the invention are used in a device in a manner that they are arranged parallel to each other, the movers of the two parallel-arranged reciprocating power generating modules can be connected by the use of a rigid structure for synchronizing their movement. However, when they are configured in a system that is not move linearly, the more than two reciprocating power generating modules can be arranged in a manner that they are not parallelized with each other and thus to be used as kinetic energy recovery device.

From the above description, it is noted that the reciprocating power generating module of the invention can be driven by any pneumatic device or hydraulic device, such as a piston-rod tidal generator. Moreover, as the present invention is able to utilize the mass of its mover to absorb kinetic energy, it can be adapted for portable electronic devices, such as computer mouse or accessories of gaming consoles and used as the primary structure of a power generating unit.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A reciprocating power generating module, comprising:
a guide;
a magnet, being an integrated unit composed of a plurality of magnetic elements aligned one next to another in a manner that poles of any one of the plural magnetic elements are orientated to repel poles of its neighboring magnetic elements; and
a coil, being wound around the guide;
wherein, the magnet is capable of being driven to move linearly by the defining of the guide; and the magnet and the coil is being arranged in a manner selected from the group consisting of: receiving the magnet inside the guide while arranging the coil outside the guide, and receiving the coil inside the guide while arranging the magnet outside the guide.

2. The reciprocating power generating module of claim 1, wherein each magnetic element is an anisotropic magnet.

3. The reciprocating power generating module of claim 1, wherein the magnet is being received inside an accommodation space formed in the guide while arranging the coil to be wound on the outer wall of the guide.

4. The reciprocating power generating module of claim 3, further comprising:
a back iron, being arranged outside the coil while surrounding the same.

5. The reciprocating power generating module of claim 1, wherein the guide are attached by an elastic member and a buffering member respectively at the two ends thereof.

6. The reciprocating power generating module of claim 1, wherein the guide are attached by magnetic objects respective at the two ends thereof in a manner that the magnetic objects repel the two ends of the magnet.

7. The reciprocating power generating module of claim 1, wherein the guide are attached by weights at the two ends thereof.

8. The reciprocating power generating module of claim 1, wherein the coil is a multi-cell coil having a plurality of sub-coils being defined in the cells thereof in a manner that each sub-coil is wound on the guide by a loops selected from the group consisting of a clockwise loop and a counterclockwise loop.

9. The reciprocating power generating module of claim 1, wherein the coil is a multi-cell coil having a plurality of sub-coils being defined in the cells thereof in a manner that the plural sub-coils are wound on the guide following the same direction while being connected to each other by a manner selected from the group consisting of a serial connection and a parallel connection.

10. The reciprocating power generating module of claim 1, wherein the coil is wound for enabling a single-phase output.

11. The reciprocating power generating module of claim 1, wherein the coil is wound is wound inside out for enabling a two-phase output.

12. The reciprocating power generating module of claim 1, wherein the coil is wound is wound inside out for enabling a three-phase output.

13. The reciprocating power generating module of claim 1, wherein a magnetic material is disposed at a position between any two neighboring magnetic elements to be used for altering the type of flux path.

14. The reciprocating power generating module of claim 1, wherein a soft magnetic material is disposed at a position between any two neighboring sub-coils for enhancing the affection of magnetic flux variation upon the coil.
